(19) United States
(12) Patent Application Publication
(10) Pub. No.: US 2024/0394599 A1
(43) Pub. Date: Nov. 28, 2024

(54) Method for Determining a Machine Learning Model Architecture for Detecting Anomalies in Sensor Signals

(71) Applicant: Robert Bosch GmbH, Stuttgart (DE)

(72) Inventors: Hunor Istvan Lukacs, Odorheiu Secuiesc (RO); Janos Botzheim, Budapest (HU); Tamas Fischl, Martonvásár (HU)

(21) Appl. No.: 18/669,844

(22) Filed: May 21, 2024

(30) Foreign Application Priority Data
May 22, 2023 (DE) 10 2023 204 761.6

(51) Int. Cl. G06N 20/00

(52) U.S. Cl. CPC G06N 20/00

(57) ABSTRACT

A method for determining a machine learning model architecture for detecting anomalies in sensor signals includes generating a population for an evolutionary algorithm, each individual of the population is a machine learning model obtained based on an encoding of the machine learning model using a parametrically modeled curve. The respective parametrically modeled curve represents a relationship between a number of neurons and a number of layers of the respective machine learning model. The method further includes performing detection of anomalies by each individual using a training data set to determine and assign an error value of each individual to the individual. The error value determines an accuracy of detection of anomalies of the respective individual based on a complexity of the respective individual. The method also includes performing a modification of the individuals according to the evolutionary algorithm.

This application claims priority under 35 U.S.C. § 119 to patent application no. DE 10 2023 204 761.6, filed on May 22, 2023 in Germany, the disclosure of which is incorporated herein by reference in its entirety.

The disclosure relates to a method for determining a machine learning model architecture for detecting anomalies in sensor signals. The disclosure also relates to a computer program, a device and a storage medium for this purpose.

### BACKGROUND

As digitalization progresses in industry, more and more data is becoming available, particularly in manufacturing, product development and the service sector. Analyzing and evaluating this data can be an extensive task, and there are various methods for solving it. In particular, the use of artificial intelligence to analyze industrial data is becoming increasingly important today in order to understand the correlations in the data. For example, there are numerous AI-based model architectures available to detect and derive relationships in data. In many cases, however, it can be an iterative modeling process where finding the right architecture that provides the right accuracy for a given task is the result of multiple iterations.

### SUMMARY

The subject matter of the disclosure is a method having the features of claim 1, a computer program having the features of claim 8, a device having the features of claim 9 and a computer-readable storage medium having the features of claim 10. Further features and details of the disclosure will emerge from the respective dependent claims, the description and the drawings. Features and details which are described in connection with the method according to the disclosure naturally also apply in connection with the computer program according to the disclosure, the device according to the disclosure and the computer-readable storage medium according to the disclosure, and vice versa in each case, so that reference is or can always be made to the individual aspects of the disclosure with respect to the disclosure.

In particular, an object of the disclosure is a method for determining a machine learning model architecture for detecting anomalies in sensor signals, comprising the following steps:
generating a population for an evolutionary algorithm, wherein each individual of the population is a machine learning model obtained based on an encoding of the machine learning model using a parametrically modeled curve,
wherein the respective parametrically modeled curve represents a relationship between a number of neurons and a number of layers of the respective machine learning model,
performing detection of anomalies by each individual using a training data set to determine and assign an error value of each individual to the individual, wherein the error value determines an accuracy of detection of anomalies of the respective individual taking into account a complexity of the respective individual,
performing a modification of the individuals according to the evolutionary algorithm,
selecting one of the individuals based on repeatedly performing the detection and modification taking into account the error value.

A machine learning model architecture can comprise a number of layers and neurons of part or all of the machine learning model and/or a structural arrangement of the layers and neurons within the machine learning model. The type of anomalies in a data set can vary. The anomalies can be the result of a random measurement error or the result of systematic behavior of a product or machine or the environment or a combination thereof. In particular, small quantities of anomalies are detected in large data sets. In particular, evolutionary algorithms are a group of optimization techniques in which a problem is solved by creating a random population of solutions and then improving them through a succession of generations of solutions. Evolutionary algorithms can be advantageous for finding solutions to complex problems. The coding can also be understood as a compression in which a reduction of the dimensions and/or a reduction to essential features is carried out. The parametrically modeled curve is preferably determined by at least one parameter, wherein the at least one parameter determines the shape of the parametrically modeled curve. In simple terms, the error value can represent the fact that the accuracy of the respective individual is rewarded, while, at the same, time the complexity of the respective individual is penalized. The training data set can have a plurality of sensor signals, wherein the sensor signals can each have a label that indicates whether an anomaly is present in the respective sensor signal. The labelling can be used to determine whether an existing anomaly has been correctly detected by the respective machine learning model. The training data set results in particular from measurements in the production of a MEMS (Micro Electro Mechanical System) based angular rate sensor, which is used in the automotive industry, for example. It is possible that the error value is taken into account to the extent that the selected individual has the lowest error value.

A further advantage within the scope of the disclosure is achievable if the machine learning model comprises an autoencoder, wherein the autoencoder comprises an encoder module and a decoder module, wherein encoding is performed by the encoder module and the decoder module is configured to perform decoding. In particular, an autoencoder is a type of artificial neural network used for dimensionality reduction, data compression and reconstruction. In other words, an encoder module is preferably responsible for compressing data by encoding the input data into a compact vector or low-dimensional representation. In other words, a decoder module is particularly responsible for reconstructing the original data from the compressed representation. In a preferred embodiment, the autoencoder is formed as a symmetric autoencoder, wherein symmetry refers in particular to the architectural symmetry between the encoder and the decoder.

In the context of the disclosure, it can be provided that the encoding comprises a dimensional reduction of the training data in order to obtain a compressed representation of the training data,

and the decoding comprises reconstruction of the dimension-reduced training data to obtain a reconstruction of the compressed representation of the training data,

wherein the detection of anomalies is performed on the basis of a comparison between the training data and the reconstruction of the compressed representation of the training data. In particular, the comparison is a determination of a deviation between the training data and the reconstruction of the compressed representation of the training data. In one embodiment, this deviation can be determined by subtracting the reconstruction of the compressed representation of the training data from the training data.

Furthermore, within the scope of the disclosure, it can be provided that the parametrically modeled curve is a quadratic Beziér curve. In particular, a Bézier curve is defined by a series of points, which can be referred to as control points. These control points can define the shape of the curve. In particular, the curve is calculated by a mathematical formula that determines the position of each point on the curve. There are different types of Bézier curves, such as linear, quadratic and cubic curves, which can differ in the number of control points. Due to its advantageous number of control points in terms of complexity and accuracy, the quadratic Bézier curve is used in a preferred embodiment.

Furthermore, it is optionally possible within the scope of the disclosure that the modification of the individuals according to the evolutionary algorithm comprises a mutation with the following steps:
generating at least two clones for each original individual,
modifying at least one parameter of the parametrically modeled curve for at least one clone, wherein one of the clones remains unchanged,
performing the detection of anomalies by each clone using the training data set to determine the error value of each clone and assign it to the clone,
transferring the at least one modified parameter of the clone with the lowest error value to the at least one further clone,
repeating the modification, performing, detection and transfer until each parameter of the parametrically modeled curve has been modified once to determine an optimized clone,
replacing the respective original individual with the optimized clone.

In particular, a clone is an exact copy of the respective original individual in relation to its parametrically modeled curve. The modification of the at least one parameter is preferably carried out on all but one of the clones present. The at least one parameter of the parametrically modeled curve preferably determines a shape of the parametrically modeled curve. In other words, if the shape of the parametrically modeled curve is determined by several parameters, each of the parameters can be modified once for one of the clones.

A further advantage can be that the modification of the individuals according to the evolutionary algorithm comprises a gene transfer with the following steps:
dividing the population into two halves, wherein the individuals of a superior half have a lower error value than the individuals of an inferior half,
transferring the parameters of the parametrically modeled curve of a randomly selected individual of the superior half to a randomly selected individual of the inferior half.

It is conceivable that the population is divided after a previous sorting of the population by error value.

It can also be possible for the error value to be determined on the basis of a deviation and a hyperparameter and is preferably calculated according to the following formula, wherein λ is the hyperparameter:

$$error value = deviation + λ * complexity$$

wherein the deviation represents the accuracy of the detection of anomalies and the complexity represents a ratio between a number of trainable parameters of the machine learning model and a maximum possible number of trainable parameters of the machine learning model. In particular, a hyperparameter is an external configuration variable that can be used for training machine learning models. Hyperparameters are preferably set manually before training a model. The calculation of the error value according to said formula advantageously takes into account both the deviation and the complexity, wherein an influence of the complexity can be individually determined depending on the application using the hyperparameter λ.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features and details of the disclosure will emerge from the following description, in which embodiment examples of the disclosure are described in detail with reference to the drawings. The features mentioned in the claims and in the description can each be essential to the disclosure individually or in any combination. Shown are:

FIG. 1 a schematic visualization of a method, a device, a storage medium, and a computer program according to embodiment examples of the disclosure.

FIG. 2 a schematic illustration of an exemplary autoencoder architecture,

FIG. 3 a schematic illustration of an individual in abstract space according to embodiment examples of the disclosure,

FIG. 4 a schematic illustration of a possible individual according to embodiment examples of the disclosure,

FIG. 5 a schematic illustration of another possible individual according to embodiment examples of the disclosure,

FIG. 6 a schematic illustration of a histogram of an anomaly detection

### DETAILED DESCRIPTION

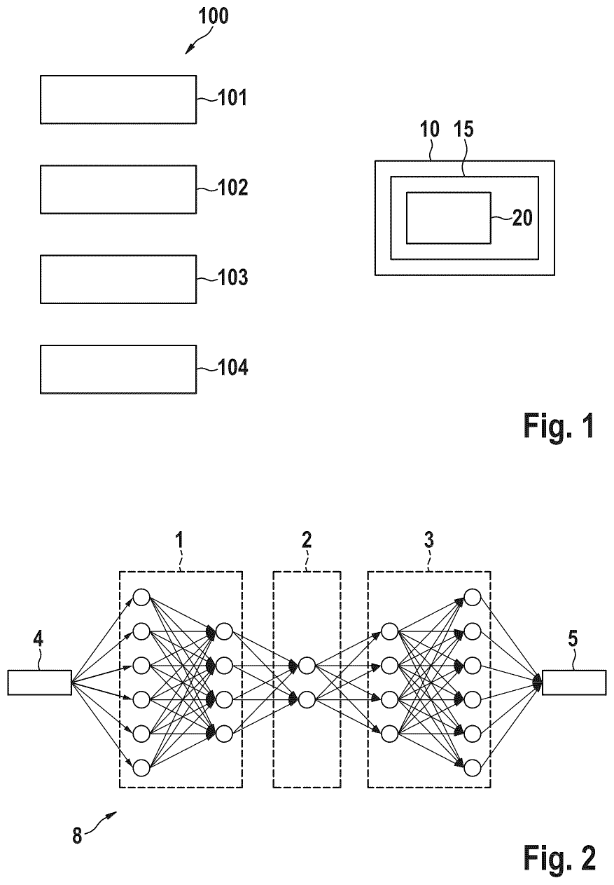

FIG. 1 schematically illustrates a method 100, a device 10, a storage medium 15 and a computer program 20 according to embodiment examples of the disclosure.

In a first step 101 according to the embodiment example according to FIG. 1, a population for an evolutionary algorithm is generated, wherein each individual of the population is a machine learning model obtained based on an encoding of the machine learning model using a parametrically modeled curve, wherein the respective parametrically modeled curve represents a relationship between a number of neurons and a number of layers of the respective machine learning model. In a second step 102, detection of anomalies by each individual is performed using a training data set to determine and assign an error value of each individual to the individual, wherein the error value determines an accuracy of detection of anomalies of the respective individual considering a complexity of the respective individual. In a third step 103, the individuals are modified in accordance with the evolutionary algorithm. In a fourth step 104, one of the individuals is selected on the basis of a repeated execution of the detection and modification, taking into account the error value.

In [2], wherein the references are given in square brackets at the end of the description, an autoencoder 8 is specifically a type of artificial neural network used in unsupervised learning tasks to learn efficient encoding of unlabeled data. The autoencoder model 8 preferably consists of an encoder 1, a code 2 and a decoder 3 (see FIG. 2). In particular, the autoencoder 8 provides two main functions, the encoding function and the decoding function. The encoding function preferably converts the input data 4 into an encoded representation, while the decoding function is used to restore the original input data 4 from the encoded representation, which is shown schematically in FIG. 2 with the output data 5. Using these functions, the autoencoder 8 can perform dimensional reduction to learn an efficient representation. For symmetric autoencoders, symmetry refers in particular to the architectural symmetry between the encoder 1 and the decoder 3. The architecture of the decoder 3 can be the mirrored encoder 1 of the code 2.

In particular, the bacterial evolutionary algorithm (BEA) [6, 4] is a general optimization method in which each bacterium represents a solution to the original problem, in the present case each bacterium can represent a symmetric autoencoder architecture with fully connected structure. The optimization process preferably consists of three main steps: First, the initial population can be randomly generated, then the two main operators, bacterial mutation and gene transfer, are preferably performed in each generation. The number of generations can be an abort criterion and is indicated by the hyperparameter N_{gen}. In particular, at the end of the algorithm, the solution will be the bacterium with the lowest error value according to the corresponding evaluation criteria.

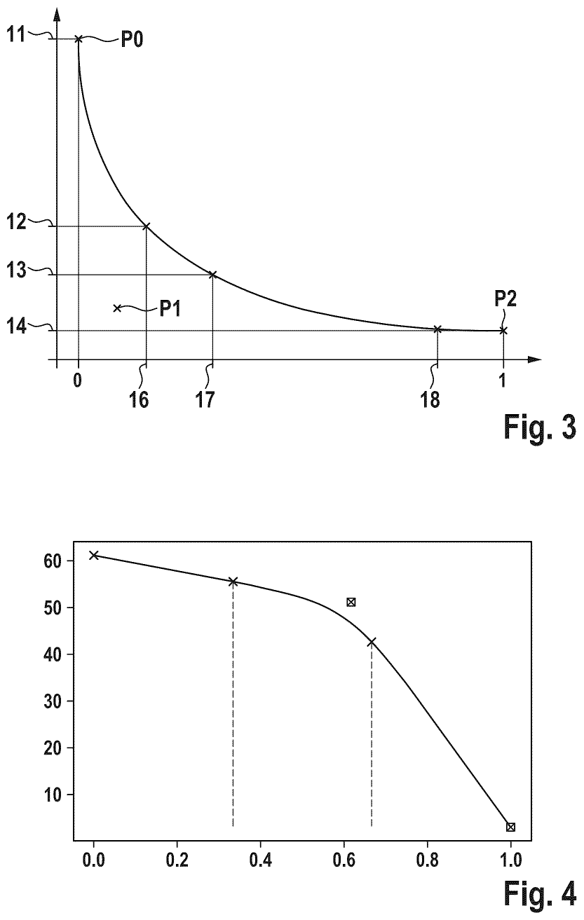

Each bacterium can encode a symmetric autoencoder in an abstract space based on the quadratic Bézier curves. In particular, Bézier curves are used to represent the relationship between the number of neurons in the layers of the model. Any desired architecture can be represented by a well-chosen Bézier curve with a suitable degree of curvature, if the method according to an embodiment example of the disclosure is followed and the boundary conditions are adjusted accordingly. The quadratic Bézier curve can be particularly advantageous for an application according to the disclosure. Due to the symmetry, it can be sufficient to encode the architecture of encoder 1 so that the architecture of decoder 3 is simply the mirrored encoder 1 at code 2. The representation of the architecture in abstract space on the basis of Bézier curves is shown in FIG. 3. In particular, the horizontal axis is an imaginary axis and the vertical axis represents a number of neurons.

In particular, the quadratic Bézier curve is the path covered by the function B(t) at the control points P₀, P₁ and P₂:

$$B ( t ) = {P}_{0} * {( 1 - t )}^{2} + {P}_{1} * 2 t ( 1 - t ) + {P}_{2} * {t}^{2} , 0 \leq t \leq 1$$

Rational Bézier curves can add adjustable weights w₀, w₁ and w₂ to the control points P₀, P₁ and P₂ respectively:

$$B ( t ) = \frac{{P}_{0} * {w}_{0} * {( 1 - t )}^{2} + {P}_{1} * {w}_{1} * 2 t ( 1 - t ) + {P}_{2} * {w}_{2} * {t}^{2}}{{w}_{0} * {( 1 - t )}^{2} + {w}_{1} * 2 t ( 1 - t ) + {w}_{2} * {t}^{2}} , 0 \leq t \leq 1$$

Changing the curve by changing the parameters of the B(t) functions described by the above formula preferably leads to different architectures.

In a preferred embodiment, the coding of the architecture is subject to the following constraints in the abstract representation:
1) P₀, is set to [0, input dimension 11].
2) The x coordinate of point P₂ is set to 1
3) The x coordinate of point P₁∈[0.1]
4) The y-coordinate of the point P₁∈[coding variable, input dimension]
5) w₀=w₂=1, while w₁=5

The restriction regarding the y-coordinate of the P₁ control point can be necessary if a symmetrical autoencoder architecture is coded. If this value were greater than the input dimension, the autoencoder could learn the identity. For other, non-autoencoder architectures in particular, this restriction is not necessary.

The restriction regarding the weighting values can contribute to the fact that the shift of the control point P₁ has an effect on the curve. If the w₁ value were low, then in particular all curves generated by three control points would only be a line between P₀ and P₂.

In a preferred embodiment, the degree of freedom (DoF) is four:
1) Code size (the y-coordinate of the P₂ point)
2) N_{enc_layers}: Number of hidden layers in the encoder (preferably the same as in the decoder)
3) The x coordinate of the P₁ control point
4) The y coordinate of the P₁ control point

Since the DoF is four, preferably each bacterial individual represents a symmetric autoencoder architecture with fully connected structure using only four values.

In one embodiment example, N_{enc_layers} of equidistant points in the interval [0, 1] are taken on the horizontal (imaginary) axis, as shown in FIG. 3. The vertical axis in FIG. 3 preferably corresponds to a number of neurons, the horizontal axis is in particular an imaginary axis and can represent the respective layers. By projecting these points onto the curve, the corresponding N_{enc_layers} intersections are obtained. The rounded y-coordinate value of the intersection point preferably indicates the number of neurons that the corresponding layer contains. At the x-coordinate 0, the number of neurons corresponds in particular to the input dimension 11. A corresponding number of neurons 12 of the first layer 16 are present at the x-coordinate of the first layer 16. In particular, a corresponding number of neurons 13 of the second layer 17 are present at the x-coordinate of the second layer 17. Accordingly, a corresponding number of neurons of this layer are present at the x-coordinate of the N_{enc_layers}-th layer 18. In particular, a number of neurons 14 of code 2 are present at the x-coordinate of 1. To obtain the y-coordinate of the intersection point, the t timestamp can first be calculated, which corresponds to the x-coordinate. To do this, the quadratic equation can be solved for t. For example, the points Pᵢₓ and P_{iy} denote the x and y coordinates of the control point Pᵢ:

$$A = {P}_{0 x} * {w}_{0} - 2 * {P}_{1 x} * {w}_{1} + {P}_{2 x} * {w}_{2} - x * {w}_{0} + x * 2 {w}_{1} - x * {w}_{2}$$

$$B = 2 * {P}_{0 x} * {w}_{0} + 2 * {P}_{1 x} * {w}_{1} + x * 2 {w}_{0} - x * 2 {w}_{1}$$

$$C = {P}_{0 x} * {w}_{0} - x * {w}_{0}$$

then t is, in particular, the solution from the quadratic formula:

$$t = \frac{- B + \sqrt{{B}^{2} - 4 A C}}{2 A + ϵ}$$

For t₂ with −\sqrt{B²−4AC} in the nominator, no solution is possible, especially in this case, as t must lie in the interval [0, 1]. By inserting the derived t value into the 2nd formula, the coordinates of the intersection point on the Bézier curve are obtained, which corresponds to the t timestamp. The associated autoencoder architecture can then have the following form:

$$Encoder : [ {ξ}_{inp} , {ξ}_{1} ] \to [ {ξ}_{1} , {ξ}_{2} ] \to … \to [ {ξ}_{enc \_ layers} , {ξ}_{code} ]$$

$$Decoder : [ {ξ}_{code} , {ξ}_{enc \_ layers} ] \to … \to [ {ξ}_{2} , {ξ}_{1} ] \to [ {ξ}_{1} , {ξ}_{inp} ]$$

wherein ξᵢ can be the number of neurons/nodes in the i-th layer, ξᵢₙₚ the number of nodes in the input layer, ξ_{code} the number of nodes in the code and ξ_{enc_layers} the number of nodes in the N_{enc_layers}-th layer. [ξᵢₙ, ξₒᵤₜ] preferably stands for a fully linked layer with a number ξᵢₙ of input nodes and a number ξₒᵤₜ of output nodes.

### Examples

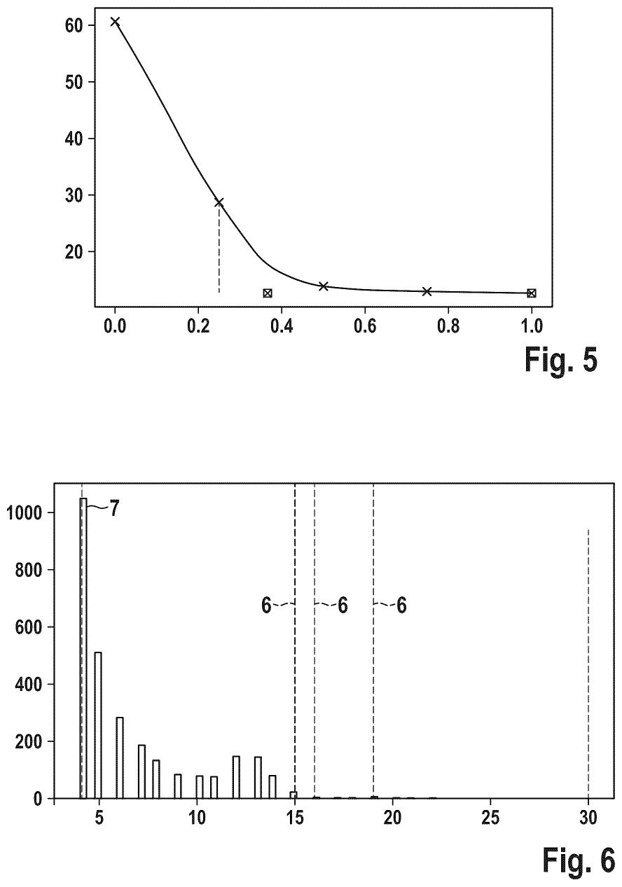

FIGS. 4 and 5 show two different bacteria, respectively individuals, while the table below shows the corresponding architectures of the autoencoder. The horizontal axis of FIGS. 4 and 5 preferably represents a number of layers and the vertical axis represents a number of neurons. The input dimension in this embodiment example is 61. In particular, in the table, each bacterium has the following form: [code_size; N_{enc_layers}; P₁ₓ; P₂ₓ], which can refer to the aforementioned four degrees of freedom, while in the autoencoder architecture [IN, OUT] can represent a fully connected layer with a number of IN input nodes and a number of OUT output nodes.

| | | Autoencoder architecture |
|---|---|---|
| Id | Bacterium Genes | (fully connected layers) |
| 1 | [3; 2; 0.617; 51.207] | [61, 55] → [55, 43] → [43, 3] → |
| | | [3, 43] → [43, 55] → [55, 61] |
| 2 | [13; 3; 0.363; 13] | [61, 29] → [29, 14] → [14, 13] → |
| | | [13, 13] → [13, 13] → |
| | | [13, 14] → [14, 29] → [29, 61] |

By evaluating an individual, an error value can be assigned to it so that accuracy is rewarded and complexity has a negative effect.

In particular, the final error value of an individual has the following form:

$$error = loss + λ * complexity$$

wherein λ is a hyperparameter of the algorithm that can represent a ratio between accuracy and complexity. According to an embodiment example, the determination of the loss value for an individual consists of two steps. First, an autoencoder is preferably trained with the architecture encoded by the individual. At the beginning of the evolutionary algorithm, according to one embodiment, a data set is divided into a training set (70%), a validation set (15%) and a test set (15%). To prevent overfitting, an early stop can be used in combination with a learning rate planner. In the second step, the trained autoencoder preferably splits the entire data set into two parts based on a standard deviation threshold (Σ) of the reconstruction errors: the outliers and the anomalies. In particular, the data points whose reconstruction error is smaller than the threshold value are the outliers, while the remaining data points are the anomalies.

For each architecture, a different threshold value can be determined so that all ground truth anomalies belong to the anomalies, and at the same time, it is especially a goal to find all true anomalies. FIG. 6 shows how the number of anomalies can change by choosing different Σ values, and also that the three ground truth anomalies can lie outside 15Σ, while the fourth lies at Σ=4. Then the loss term is preferably the ratio between the number of data points labeled as anomalies and the number of data points in the entire data set.

$${loss}_{anomaly} = \frac{{N}_{anomalies}}{{N}_{all \_ data \_ points}}$$

The complexity term is preferably the ratio between the trainable parameters of the model (N_{params_model}) and the maximum possible trainable parameters that a model can have (N_{params_max}). In an embodiment example, the trainable parameters are the weights and biases in the artificial neural network. In one possible embodiment, the maximum possible trainable parameters that an individual can have are determined by the N_{enc_layers} hyperparameter of the algorithm. In particular, this hyperparameter specifies the maximum number of layers in the architecture of the encoder between the input layer and the code (which is mirrored in the decoder). In order to obtain the maximum possible number of trainable parameters, an assumption can be made that each layer contains the maximum number of neurons, which according to an embodiment example is the number of neurons of the input layer.

$$complexity = \frac{{N}_{param \_ model}}{{N}_{params \_ m ax}} = \frac{{N}_{params \_ model}}{2 ( {N}_{enc \_ layers} + 1 ) * ( {inp}_{dim}^{2} + {inp}_{dim} )}$$

The bacterial mutation operator is preferably applied to each individual of the population [7]. It generates N_{clones}+1 clones for each individual. A group of genes can be randomly selected and changed into N_{clones}, wherein one clone is preferably unchanged. The best clone out of N_{clones}+1 clones is selected in particular to transfer the mutated genes into the other N_{clones}. The same procedure can be repeated with the group of genes not yet selected until all genes in the bacterial chromosome have been selected exactly once. The best clone preferentially replaces the original individual in the population and discards the other clones.

The gene transfer operator works in particular at the population level. The bacterial population can be divided into two halves according to the error definition, wherein the individuals with a low loss value belong to the better half, while the worse individuals belong to the worse half. In a preferred embodiment, a randomly selected individual from the upper half of the population (donor) can transfer genes to another randomly selected bacterium from the lower half (acceptor). The number of genes transferred is let, in particular a parameter of the algorithm. After the gene transfer, the population is preferably sorted again and the process is repeated N_{inf} times.

To evaluate a bacterial individual, the encoded autoencoder model can be trained first. The model training process between bacteria can be independent of each other. The goal of this training process is preferably to train the autoencoder such that the reconstruction error on the validation set is minimized. Different architectures can result in different minimum validation errors. For example, the following techniques are used in the training process.

Mini-batch training [1] can be used to train the model. The mini-batch in particular is a set of samples, a fixed size subset of the original dataset, and in each iteration the model is preferably trained on a different subset until all samples of the original dataset have been used. In a preferred embodiment, the hyperparameter indicating the size of a batch is N_{batch_size}.

To avoid overfitting, early stopping [8], an optimization technique and a form of regularization, can be used. Early stopping can be used to stop the training process before the model starts to overfit. To decide whether the model is overfitting during early stopping, the validation loss is preferably tracked. As soon as the validation loss for N_{patience} iterations increases or at least does not decrease, the learning process is preferably stopped. In particular, N_{patience} is a hyperparameter of the algorithm. The other abort criterion can be N_{max_iteration}, the maximum number of iterations.

An Adam optimizer [5], which is an extended version of Stochastic Gradient Descent, can also be used to train the autoencoder. In particular, the Adam optimizer uses adaptive learning rates based on the second moments of the gradients. It can calculate the exponential moving average of the gradients and the quadratic gradients, so that the Adam algorithm can be interpreted as a combination of the gradient descent with momentum and the RMSP method.

In particular, the Adam optimizer uses an adaptive learning rate so that all parameters are updated at an individual learning rate. All individual learning rates can use the initial learning rate, which is a parameter of the algorithm, as an upper bound. By decreasing this learning rate during training, the loss in the final steps can be reduced. The learning rate is preferably reduced during training according to the following scheme. First, the learning rates are preferably set=[lr₁, lr₂, . . . , lrₙ]; a list that is a hyperparameter and contains the learning rates (Ir₁, . . . Irₙ) in decreasing order. At the start of training, Adam's learning rate parameter is Ir₁ in particular. The learning rate can be reduced as follows. The optimizer preferably uses the learning rate Irᵢ and when early stopping is triggered, the learning rate is reset to the next (reduced) value Irᵢ₊₁ and the early stopping counter is reset. If early stopping is triggered when Irₙ is used, training is preferably aborted.

The above explanation of the embodiments describes the disclosure solely within the scope of examples. Of course, individual features of the embodiments can be freely combined with one another, if technically feasible, without leaving the scope of the disclosure.
[1] Dimitri Bertsekas. “Incremental Gradient, Subgradient, and Proximal Methods for Convex Optimization: A Survey”. In: Optimization 2010 (July 2015).
[2] Zhiyuan Cao et al. “Scalable Distribution Systems State Estimation Using Long Short-Term Memory Networks as Surrogates”. In: IEEE Access PP (January 2020), pp. 1-1. DOI: 10.1109/ACCESS.2020.2967638.
[4] John H Holland. “Adaptation in natural and artificial systems”. In: Ann Arbor (1975).
[5] Diederik P. Kingma and Jimmy Ba. “Adam: A Method for Stochastic Optimization”. In: CoRR abs/1412.6980 (2014).
[6] N. E. Nawa and T. Furuhashi. “Fuzzy system parameters discovery by bacterial evolutionary algorithm”. In: IEEE Transactions on Fuzzy Systems 7.5 (1999), pp. 608-616. DOI: 10.1109/91.797983.
[7] Charles Phiri et al. “Fuzzy rule-based model for outlier detection in a Topical Negative Pressure Wound Therapy Device”. In: ISA Transactions 117 (February 2021). DOI: 10.1016/j.isatra.2021.01.046.
[8] Tong Zhang and Bin Yu. “Boosting with early stopping: Convergence and consistency”. In: The Annals of Statistics 33.4 (August 2005). DOI: 10.1214/009053605000000255.

What is claimed is:

1. A method for determining a machine learning model architecture for detecting anomalies in sensor signals, comprising:
generating a population for an evolutionary algorithm, wherein each individual of the population is a machine learning model obtained based on an encoding of the machine learning model using a parametrically modeled curve, wherein the respective parametrically modeled curve represents a relationship between a number of neurons and a number of layers of the respective machine learning model;
performing detection of anomalies by each individual using a training data set to determine and assign an error value of each individual to the individual, wherein the error value determines an accuracy of detection of anomalies of the respective individual based on a complexity of the respective individual;
performing a modification of the individuals according to the evolutionary algorithm; and
selecting one of the individuals based on repeatedly performing the detection and modification based on the error value.

2. The method according to claim 1, wherein:
the machine learning model comprises an autoencoder,
the autoencoder comprises an encoder module and a decoder module,
encoding is performed by the encoder module and the decoder module is configured to perform decoding.

3. The method according to claim 2, wherein:
the encoding comprises a dimensional reduction of training data of the training data set in order to obtain a compressed representation of the training data,
the decoding comprises reconstruction of the dimension-reduced training data to obtain a reconstruction of the compressed representation of the training data, and
the detection of anomalies is performed based on a comparison between the training data and the reconstruction of the compressed representation of the training data.

4. The method according to claim 1, wherein the parametrically modeled curve is a quadratic Beziér curve.

5. The method according to claim 1, wherein:
the modification of the individuals according to the evolutionary algorithm comprises a mutation with the following steps:
generating at least two clones for each original individual,
modifying at least one parameter of the parametrically modeled curve for at least one clone, wherein one of the clones remains unchanged,
performing the detection of anomalies by each clone using the training data set to determine the error value of each clone and assign it to the clone,
transferring the at least one modified parameter of the clone with the lowest error value to the at least one further clone,
repeating the modification, performing, detection, and transfer until each parameter of the parametrically modeled curve has been modified once to determine an optimized clone, and
replacing the respective original individual with the optimized clone.

6. The method according to claim 1, wherein:
the modification of the individuals according to the evolutionary algorithm comprises a gene transfer with the following steps:
dividing the population into two halves, wherein the individuals of a superior half have a lower error value than the individuals of an inferior half, and
transferring the parameters of the parametrically modeled curve of a randomly selected individual of the superior half to a randomly selected individual of the inferior half.

7. The method according to claim 1, wherein:
the error value is determined based on a deviation and a hyperparameter and is calculated according to the following formula, wherein λ is the hyperparameter:
error value=deviation+λ*complexity
the deviation represents the accuracy of the detection of anomalies and the complexity represents a ratio between a number of trainable parameters of the machine learning model and a maximum possible number of trainable parameters of the machine learning model.

8. The method according to claim 1, wherein a computer program comprises instructions that, when the computer program is executed by a computer, cause the computer to carry out the method.

9. A device for data processing, configured to carry out the method according to claim 1.

10. A non-transitory computer-readable storage medium, comprising instructions which, when executed by a computer, cause the computer to carry out the method according to claim 1.
